(19) United States
(12) Patent Application Publication
(10) Pub. No.: US 2009/0282038 A1
(43) Pub. Date: Nov. 12, 2009

(54) Probabilistic Association Based Method and System for Determining Topical Relatedness of Domain Names

(76) Inventors: Michael Subotin, Greenbelt, MD (US); Alan Sullivan, Leesburg, VA (US)

Correspondence Address: POTOMAC PATENT GROUP PLLC, P. O. BOX 270, FREDERICKSBURG, VA, 22404, US

(21) Appl. No.: 12/434,625

(22) Filed: May 2, 2009

Related U.S. Application Data
(60) Provisional application No. 61/192,942, filed on Sep. 23, 2008.

(51) Int. Cl. G06F 17/30; G06F 17/18; G06F 15/16

(52) U.S. Cl. 707/6; 702/181; 709/224; 707/E17.014

(57) ABSTRACT

Systems, computer software and methods for calculating relatedness scores which are indicative of relatedness of pairs of domain names requested by clients are described. The method includes receiving DNS traffic data, wherein the DNS traffic data includes at least domain names requested by clients and identities of the clients requesting the domain names, generating sequences of the domain names based on the received DNS traffic data, collecting co-occurrence counts for queried pairs of domain names, applying a probabilistic association estimate to the collected counts to determine the relatedness scores of the queried pairs of domain names, and storing the determined relatedness scores.

### RELATED APPLICATION

This application is related to, and claims priority from, U.S. Provisional Patent Application Ser. No. 61/192,942, filed on Sep. 23, 2008, entitled “Method and System for Determining Topical Relatedness of Domain Names” to M. Subotin and A. Sullivan, the entire disclosure of which is incorporated here by reference.

### TECHNICAL FIELD

The present invention generally relates to systems, software and methods and, more particularly, to mechanisms and techniques for determining topical relatedness of domain names based on probabilistic association.

### BACKGROUND

During the past several years, interest in data available on the Internet and Internet services has dramatically increased, in part due to the affordability of access to the Internet and in part due to the ease of obtaining fast and reliable information. Moreover, Internet users have come to realize that the amount of data that is available on the Internet is phenomenal. Various search engines are available to aid Internet users to search for desired information. Conventional search engines (e.g., those provided by Yahoo, Google, etc.) provide the user with an input box into which the user must enter keywords related to the desired information. FIG. 1 illustrates such a conventional search process, e.g., with one or more keyword(s) being input in step 100. The keyword(s) may refer, for example, to a product that the user is interested in. The keyword(s) are received by the search engine in step 110. A component of the search engine determines, in step 120, which web sites or web pages are relevant to the keyword(s) which were entered by the user. This determination is made in part by matching the keyword(s) with the content of the web sites. More specifically, the keyword input(s) entered by the user is found in the information available on, or associated with, the web page such that the web page is determined to be relevant by the search engine. A ranked list of all of the web sites that were matched to the keyword(s) is provided, in step 130, to the user, e.g., as a list of links or the like.

With this approach pages from a domain are unlikely to be displayed to the user unless user's query includes its domain name or other words included in its content verbatim. In contrast, in many scenarios the user many be interested in finding web pages related to the content of a particular domain but not belonging to the domain itself. This may be the case, for example, when a user who knows one online store specializing in a particular area is looking to find other stores which sell similar products for purposes of price comparison.

Additionally, there is an opportunity to supply ads which are embedded into the information that a user is looking for, and the advertisement industry is repositioning itself to occupy this new advertising field. More and more ads are being placed on most of the web pages visited by Internet users with the expectation that some of the users will visit those ads and at least explore, if not buy, the goods or services featured in the ads. Various companies have started to specialize in tracking consumer/client behavior such that more targeted ads are placed on the visited web pages. It is known that it is not efficient to advertise goods or services on web pages that are not related to those goods or services.

Accordingly, it would be desirable to provide systems and methods for generating and updating information about relatedness of Internet domains and web pages.

### SUMMARY

According to one exemplary embodiment, there is a method for calculating relatedness scores, which are indicative of relatedness of pairs of domain names requested by clients. The method includes receiving DNS traffic data, where the DNS traffic data includes at least domain names requested by clients and identities of the clients requesting the domain names; generating sequences of the domain names based on the received DNS traffic data; collecting co-occurrence counts for queried pairs of domain names; applying a probabilistic association estimate to the collected counts to determine the relatedness scores of the queried pairs of domain names; and storing the determined relatedness scores.

According to another exemplary embodiment, there is a server for calculating relatedness scores, which are indicative of relatedness of pairs of domain names requested by clients. The server includes an input/output interface configured to receive DNS traffic data, wherein the DNS traffic data includes at least domain names requested by clients and identities of the clients requesting the domain names. The server also includes a processor and a memory. The processor is connected to the input/output interface and it is configured to, generate sequences of the domain names based on the received DNS traffic data, collect co-occurrence counts for queried pairs of domain names, and apply a probabilistic association estimate to the collected counts to determine the relatedness scores of the queried pairs of domain names. The memory is connected to the processor and configured to store the determined relatedness scores.

According to still another exemplary embodiment, there is a computer readable medium storing computer executable instructions, wherein the instructions, when executed, implement a method for calculating relatedness scores, which are indicative of relatedness of pairs of domain names requested by clients. The method includes providing a system comprising distinct software modules, wherein the distinct software modules comprise a DNS traffic module, a sequence module, a co-occurrence module, and a probabilistic association estimate module; receiving at the DNS traffic module DNS traffic data, wherein the DNS traffic data includes at least domain names requested by clients and identities of the clients requesting the domain names; generating by the sequence module sequences of the domain names based on the received DNS traffic data; collecting co-occurrence counts for queried pairs of domain names in the co-occurrence module; applying, in the probabilistic association estimate module, a probabilistic association estimate to the collected counts to determine the relatedness scores of the queried pairs of domain names; and storing the determined relatedness scores.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram illustrating how a traditional search engine determines a web page to be presented to a user;

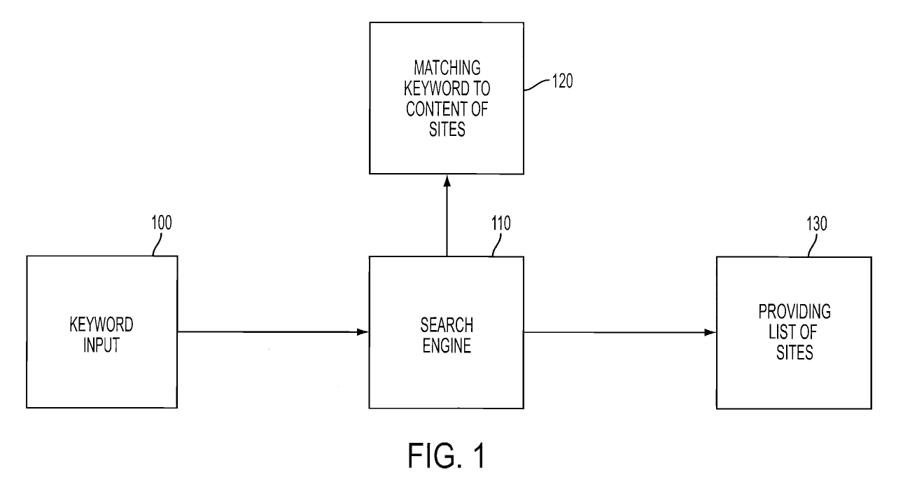

FIG. 2 is an exemplary screenshot that a client may use in a novel browser according to an exemplary embodiment;

FIG. 3 is an exemplary screenshot of the novel browser of FIG. 2;

FIG. 4 is a schematic diagram of a computer based system in which a client accesses the Internet via an Internet Service Provider;

FIG. 5 illustrates information received and stored at a Domain Name Server;

FIG. 6 illustrates sequences of domain names according to the client identity;

FIG. 7 illustrates client sessions including domain names requested by clients according to an exemplary embodiment;

FIG. 8 illustrates a time line of domain name requests according to an exemplary embodiment;

FIG. 9 illustrates a tree path of requested domain names according to an exemplary embodiment;

FIG. 10 is a schematic diagram of a computer based system in which a client accesses the Internet via an Internet Service Provider and an independent server may provide various services to the client according to an exemplary embodiment;

FIG. 11 illustrates an example of a tree path of three domain names and associated relatedness measures according to an exemplary embodiment;

FIG. 12 illustrates steps of a method for calculating a relatedness score for a pair of domain names according to an exemplary embodiment;

FIG. 13 illustrates steps of a method for calculating the relatedness score for a pair of domain names according to another exemplary embodiment;

FIG. 14 is a schematic diagram of the independent server shown in FIG. 10; and

FIG. 15 is a schematic diagram of specific modules implemented in a processor for performing the steps shown in FIGS. 12 and 13 according an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of Internet based systems having, among other things, DNS functionality. However, the embodiments to be discussed next are not limited to these systems but may be applied to other existing data systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

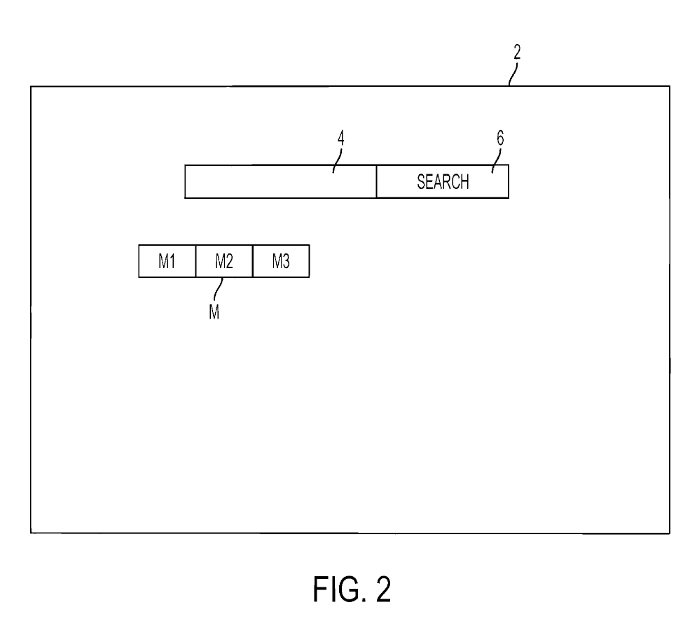

As discussed in the Background section, there is a need to develop new tools and search engines that are more accurate, faster, more reliable and more capable than the existing tools. According to an exemplary embodiment, a domain-query search engine that does not use only keywords to search for desired information is shown in FIG. 2. FIG. 2 shows a screen 2 that is presented to a user. On the screen 2, the user may see an empty box 4, in which the query may be entered. A button 6 provides the search functionality. A more sophisticated search engine according to other exemplary embodiments could be implemented as a graphical user interface or a browser with various buttons M, each button or control object being associated with a different algorithm for calculating the relatedness of domain names based on the user's input(s). Exemplary algorithms are described in detail below. This exemplary domain-query search engine accepts as an input not only keywords but also, or alternatively, a domain name of interest.

For example, as shown in FIG. 2, a user may enter the “Expedia” domain name, e.g., as “www.expedia.com”, as “expedia.com” or simply as “expedia.” Suppose that a user only knows about the Expedia web site as a site for booking an airplane, hotel, car, etc. However, if that user becomes dissatisfied, for example, with the prices quoted by this site, the user might want to search for similar sites that offer similar products or services, but maybe at a better price. Thus, according to an exemplary embodiment, the user searches for similar web sites or companies based on the relatedness of their domain names.

Based on, among other things, the concept that the collective wisdom is the best approach to follow, search engines or other applications according to these exemplary embodiments, calculate, as will be described later, a relatedness score between the input domain name or web site (e.g., “Expedia” in the example above) and other domain names or web sites. This relatedness score can, for example, be calculated based on captured data generated by various users while searching the Internet, for example, data generated in a Domain Name System (DNS) server. The DNS server, which is discussed in more detail later, is capable of storing the IP addresses of the users, the addresses of the user requested web pages, and the relationships between the users and web pages requested by those users. According to exemplary embodiments, those sites having the highest relatedness scores to the domain name(s) entered as input are then returned to the user in any desired format.

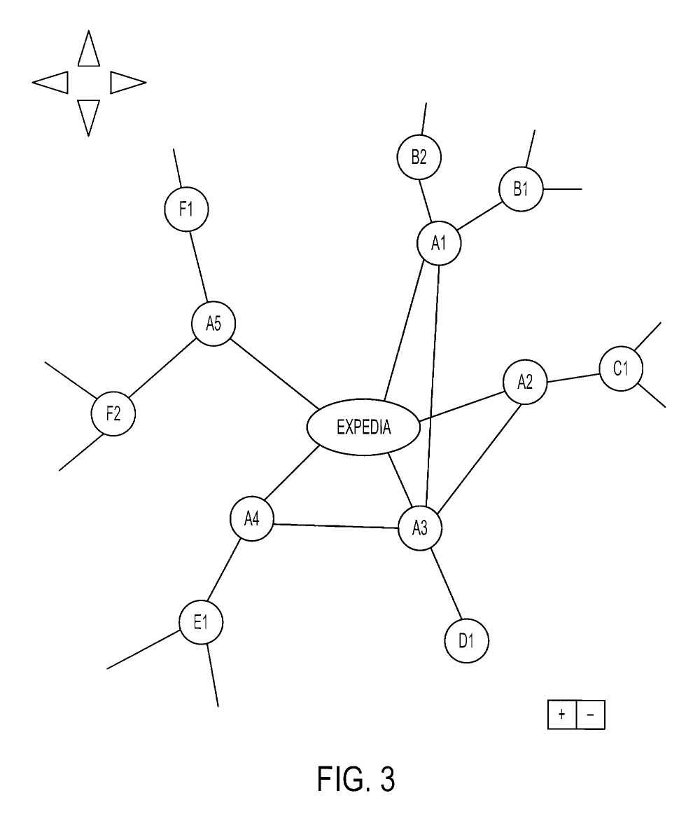

FIG. 3 shows an exemplary display screen that is provided to the user after the search is performed. This exemplary display of results could, for example, be a final output of results or could also represent an opportunity for the user to refine his or her search. In this display, an icon, text, image or marker representing the site Expedia may be positioned in the center of the figure and the topically related sites, which were identified by the relatedness search algorithm, are displayed around the main site Expedia. Links between the main site Expedia and the newly found (and related) sites may be displayed, for example, as a line that might have a length or thickness which is proportional with that site's relatedness score relative to “Expedia” (not shown). In another exemplary embodiment, the score between Expedia and the related sites is represented by displaying the links in different colors (not shown), e.g., red being highly related, yellow being somewhat related and green being less related than either red or yellow links. Other possibilities to visualize the relatedness score between the Expedia site and related sites may be used, as will be recognized by those skilled in the art.

FIG. 3 also shows that various buttons or other control objects may be provided in exemplary user interfaces which are used to provide the search results, such objects which enable the user to move to a site identified by the search by using arrows (see arrows in left upper corner of the figure) or using zoom in and out buttons (see buttons in right lower corner of the figure) to display fewer or more search results. Other buttons or control objects that streamline and simplify the navigation may be added, like for example a home button that brings the user to the initial domain name (e.g., Expedia). Alternatively, or additionally, a first button may be provided labeled “Keyword” and a second button labeled “Domain Name”. In such an embodiment, after the user enters an input into the text box on the interface, she or he can press either the “Keyword” button or the “Domain Name” button and the interface will process the search request either as a keyword search, e.g., using a conventional keyword search engine, or as a domain name search, e.g., using the techniques described below. The results can then be output using any of the aforedescribed user interface screens or other output mechanisms.

According to another exemplary embodiment, the user may navigate from one site to another site by rolling the cursor over a desired web site, which is displayed on the screen. By moving the cursor over any displayed web site, the graphical interface may, based on the calculated scores, display the links between the newly selected web site and the sites related to the selected web site. According to an exemplary embodiment, this action may reposition in the center the newly selected web site and move all the other web sites accordingly. Thus, a browsable graph may be generated on the screen as shown, for example, in FIG. 3. According to this exemplary embodiment, the user, after inputting/typing a keyword and/or a domain name, may browse other related web sites by simply using the mouse (or another point and click device) instead of typing more words, thus, simplifying the browsing process.

According to another exemplary embodiment, the graphical user interface may present the user with the information that a traditional search engine would present about a given web site, e.g., a list of hyperlinks with some text in a standard list format, albeit the websites themselves would be ordered based upon relatedness as described below. According to another exemplary embodiment, the graphical interface may present the user, when selecting a specific web site, only with those related web sites that are either geographically connected with the selected web site or with those related web sites that are temporally connected to the selected web site. For example, suppose that the user is interested to fix his flat tire and the user knows about a repair shop called FixFlatTire in his or her community. However, the user is not happy with the prices charged by FixFlatTire. Thus, the user may type, e.g., in the input box of the novel browser according to this exemplary embodiment, the domain name “FixFlatTire” and the browser could returns one or more places that may fix a flat tire, e.g., based upon the topical relatedness techniques described below, and which are also located in close geographic proximity to the FixFlatTire or to the location of the user, because the user is interested only in places that are close to his or her location, e.g., house, work place, etc. Close proximity in this sense may be defined in terms of miles or zip codes by the user prior to performing the search, e.g., by entering such information into the user interface prior to clicking the “Search” button or “Domain Name Search” button.

Regarding the temporal approach, suppose that a user intends to watch a movie around 8 pm during a certain day. The user is aware of a movie theater called BestMovie in her community. After the user enters the name of the movie theater, a browser according to these exemplary embodiments may present the user, based on the calculated relatedness scores and the desired time, with other movie theaters that offer a movie around the same time. Thus, the user is presented with a more focused search result than a traditional search engine.

According to another exemplary embodiment, a tool may be developed based on the calculated relatedness scores, and the tool presents a user with “Internet paths” followed by other users after visiting a certain domain name. For example, by knowing that many or most of Internet users that have visit the domain name “Hotels.com” after visiting the domain name “Expedia.com”, e.g., using one or more of the below described topical relatedness techniques, a company that, for certain reasons, wishes to advertise on Expedia, may decide to also advertise on Hotels as many or most of the users would be expected to transit from Expedia to Hotels. Thus, this tool may provide the user with a road map of “highways” that start from an initial domain name and continue to related domain names, such that the user may make an informed decision when selecting which domain names to target for his or her ads.

Other implementations of the relatedness score (to be described next) may be envisioned by those skilled in the art. However, a component of all such implementations is the ability to calculate the relatedness score of domain names based on the behavior of many users.

According to an exemplary embodiment, data related to client queries from DNS resolvers may be used to determine topical relatedness of various Internet domains with respect to contents of their web pages or other services they may provide to clients. This data may include information related to a time the user requested the domain time and to a physical location of the user. For that purpose, queries from DNS resolvers may be stored in dedicated files (logs) together with the IP address of the client (which may correspond to one or more clients) and the time of the request.

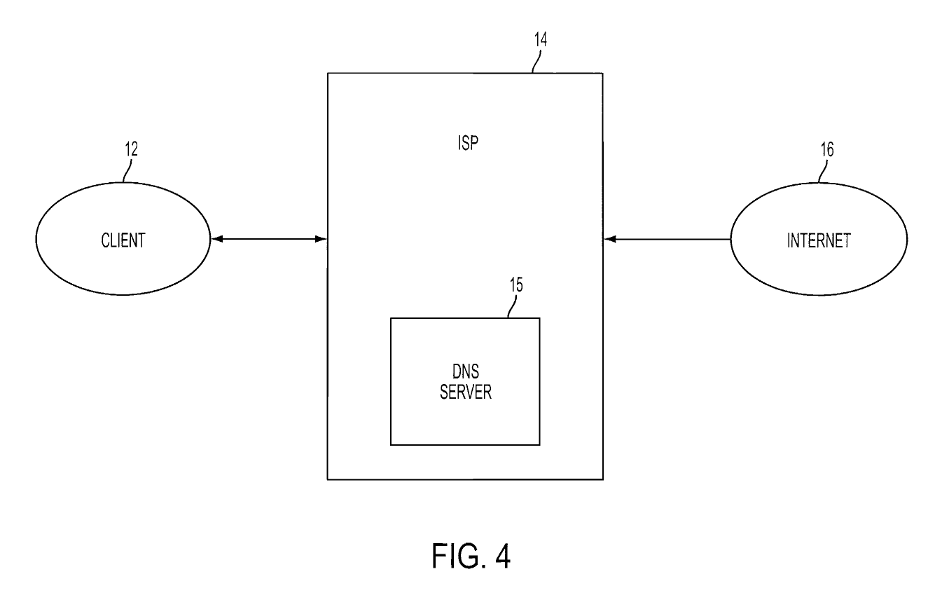

For example, as shown in FIG. 4, when a client 12 requests a certain page (each page belongs to a certain domain) from the Internet 16, the Internet service provider (ISP) 14 uses DNS services, which may be distributed over the Internet 16, or implemented in DNS server 15 within the ISP 14, to translate the domain name of the requested page to an IP address and then forwards the client's request to the appropriate domain, based on the stored IP address of the requested domain. One skilled in the art will appreciate that FIG. 4 may oversimplify the processes that are taking place and the number of nodes involved in an actual request to avoid obscuring the general concept. Additionally, it will be appreciated that the term “client” as used herein may refer to a person, an end user device (e.g., a personal computer, a personal digital assistant, a mobile phone, or the like), a browser application, or any combination thereof which sends web page requests.

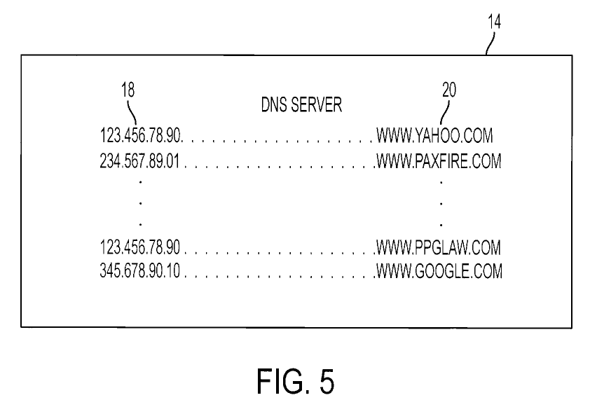

In this respect, FIG. 5 shows a table that, according to an exemplary embodiment, may be populated at an ISP (or, more precisely, on a DNS server of the ISP) and includes the IP addresses 18 of the users and the domain names 20 of the pages requested by the users. The DNS may also store a time stamp of each request (not shown) and a geographical location of the user (not shown). This information may be used for determining the topical relatedness of various Internet domains according to exemplary embodiments, as will be discussed below. It is noted that according to an exemplary embodiment, the table shown in FIG. 5 stores the IP addresses of the users together with the requested domain names in the order in which these requests are received at the DNS server.

As the security of the users is a concern for the ISP providers, one skilled in the art will appreciate that the IP addresses 18 should, preferably, not be disclosed to third parties, e.g., to protect against unauthorized tracking of the behavior of the individual users. Thus, according to an exemplary embodiment, the IP addresses of the clients are eventually discarded and only the domain names requested by the clients are used for determining the topical relatedness of the various Internet domains. The sequence of the requests and optionally, the times of the requests, may be part of the information that is used for determining the topical relatedness. However, it will be appreciated that the exemplary embodiments are not so limited and that, according to other exemplary embodiments, various information about individual clients and users could be retained and analyzed to provide personalized services to clients.

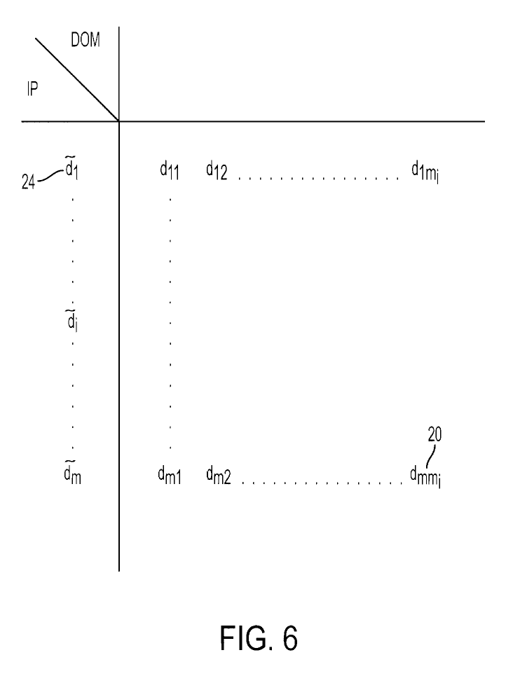

Moreover, prior to discarding the IP addresses of the clients, the entries in query logs are rearranged into intermediate sequences, one for each client IP address, with entries in each sequence appearing in the temporal order in which the queries were recorded. Thus, the IP addresses of the users are used to aggregate the domain names according to this exemplary embodiment. An example is discussed below with regard to FIG. 6 solely for facilitating the understanding of this exemplary embodiment and not for limiting the present invention.

It is noted that at least two different representations of the domain names may be used in the following exemplary embodiments, (i) symbol sequences and (ii) real-valued vectors. The first representation is discussed next in more detail. The second representation is discussed in U.S. patent application Ser. No. ______, filed concurrently herewith, entitled “Distributional Similarity based Method and System for Determining Topical Relatedness of Domain Names” to M. Subotin and A. Sullivan (herein Subotin), the entire disclosure of which is incorporated here by reference.

A collection of sequences may include sequences of different lengths with entries drawn from a set of symbols (for example, a set of domain name queries), while a collection of vectors may include vectors of the same length with real-valued entries and may be supplied with coordinate labels drawn from a set of symbols. The vector representation may be used to describe a distributional similarity method.

The sequence representation may be used to describe exemplary embodiments related to the probabilistic association method. As shown in FIG. 6, for each client (which is identified by its IP address 18), a sequence of the requested domain names _{dij} 20 may be constructed as discussed next. As discussed earlier, the domain names _{dij} 20 are the minimum information elements stored by the DNS server according to an exemplary embodiment. Supplemental information may be stored in addition to domain names _{dij} 20. For example, the sequence \tilde{d}ᵢ 24 is constructed for each IP address in the collection, with i ranging from 1 to the number m of unique client IP addresses, the sequence \tilde{d}ᵢ having entries dᵢⱼ with j ranging from 1 to ₘᵢ, where ₘᵢ is the number of queries recorded for the IP address (i.e., ₘᵢ depends on i) and each entry dᵢⱼ includes information about the query and possibly additional information, such as the timestamp of the request.

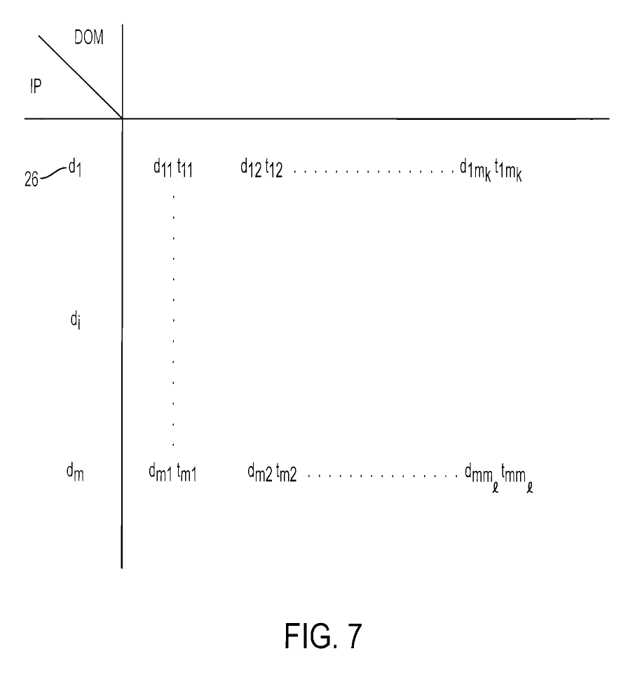

Some, all, or none of these intermediate sequences are then partitioned to generate sequences {dᵢ} 26 as shown in FIG. 7, representing client sessions, with corresponding entries dᵢⱼ and tᵢⱼ, which are domain name queries and their timestamps, respectively. Intermediate sequences may be defined based on unique IP addresses, which may not correspond to the same client when dynamic allocation of IP addresses is used. More specifically, if the DNS server collects and stores data over a period of, for example, three days, it may be that a first physical user has used IP1 during the first day, a second physical user, different from the first physical user has used the same address IP1 during the second day, and so on. Thus, according to an exemplary embodiment, the sequence \tilde{d}ᵢ 24 may include domain names requested by multiple physical users. The sequence dᵢ 26, which is calculated from the sequence \tilde{d}ᵢ 24, includes, more accurately, the domain names requested by a single physical user. For this reason, the sequence dᵢ 26 is called a client session.

Thus, client sessions may be generated to produce at least one sequence for each user (which may require partitioning the intermediate sequences \tilde{d}ᵢ if they correspond to dynamic IP addresses, as discussed above) or one sequence for each period of Internet usage. According to an exemplary embodiment, a new client session may begin whenever the time elapsed between two consecutive queries from the corresponding IP address exceeds one hour. This time period is exemplary and not intended to limit the embodiments. Thus, instead of determining when a physical user has released the IP1 and a new user is using the same IP1, a time limit may be set up to account for this change in users.

Once client session sequences 24 and/or 26 are formed as shown in FIGS. 6 and 7, the real IP addresses of all the users may be removed, thus protecting the confidentiality of the users. Therefore, the IP addresses of the users have been used only to properly generate the sequences and the real addresses of the users cannot be traced in the generated sequences 24 and/or 26.

Optional heuristics may be used in the process of generating client session sequences, either before or after partitioning them into intermediate sequences. For example, the queries may be processed to delete some of their sub-domain portions, i.e., the query graphics8.nytimes.com may be converted to nytimes.com. The queries not appearing in a certain list (e.g., a list of domains reflecting high popularity rankings) or appearing in a certain list (e.g., a list of domains known to contain sexually explicit material) may be filtered out. On many sites a user's request for a webpage and its download often triggers multiple automatic DNS queries for specialized subdomains of the site, such as image servers, as well as queries for domains of external content providers, such as advertising agencies. After subdomain details have been pruned, this may give a sequence of queries resulting from a user's request for nytimes.com a form such as nytimes.com . . . ad.doubleclick.net . . . nytimes.com, where the ellipses indicate other automatic queries resulting from the user's request for nytimes.com. It may therefore be useful to filter out a query if another query for the same domain has already appeared in the preceding “tail” of the query sequence, i.e., separated by no more than a certain number of consecutive queries or time span from the given query.

According to an exemplary embodiment, topical relatedness between a pair of domains is estimated based on the sequences 24 and/or 26 discussed above with regard to FIGS. 6 and 7. The co-occurrence of queries for the requested domains is calculated and probabilistic association measures are applied to sequences 24 and/or 26 for determining the relatedness score. Attribution of the co-occurrence property of queries may be limited to, for example, those queries disposed within a moving window of consecutive requests or within a certain time span for the same IP address.

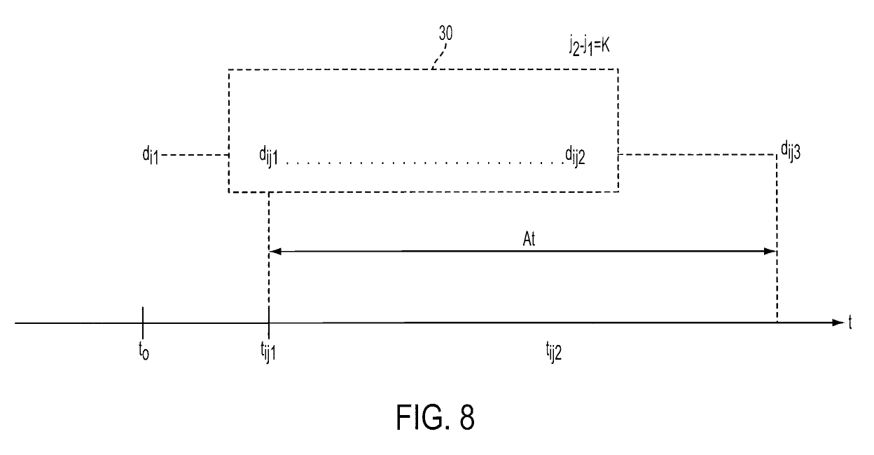

In one application, a moving window of consecutive requests may be an imaginary window 30 as shown in FIG. 8, which spans k consecutive domains. Then, for example, an event of co-occurrence of queries dᵢⱼ_{₁} and dᵢⱼ_{₂} would be considered if j₂−j₁<k, where k may have a value between 2 and 100. In other words, if at least one query of two different queries occurs outside the window 30, they are not considered to co-occur. The concept of co-occurrence is used to associate different domain names that are sequentially visited by a user.

According to another exemplary embodiment, the moving window may be based on a predetermined period of time Δt, which has elapsed between when a pair of queries are taking place. Thus, according to this exemplary embodiment, an event of co-occurrence of queries dᵢⱼ_{₁} and dᵢⱼ_{₂} is recorded if corresponding time stamps tᵢⱼ₁ and tᵢⱼ₂ satisfy the condition tᵢⱼ_{₁}−−tᵢⱼ_{₂}<Δt, where Δt may be between, for example, 1 and 60 seconds.

According to exemplary embodiments, topical relatedness scores of domains can be estimated using probabilistic methods for measuring statistical association between random variables, called herein “probabilistic association estimates.” These are computed based on occurrence counts for domain names and domain name pairs. Probabilistic association estimates used in data mining include a form of the likelihood ratio and various expressions related to mutual information between random variables, such as pointwise mutual information and information gain, as disclosed, for example, in Manning and Schutze (C. D. Manning and H. Schutze, “Foundations of Statistical Natural Language Processing”, MIT Press, 1999), the entire content of which is included here by reference. The use of probabilistic association estimates in determining topical relatedness of Internet domains can be motivated by users' tendency to visit multiple topically related sites during their browsing sessions.

According to an exemplary embodiment, a topical relatedness score between domains d_{A} and d_{B} may be estimated using pointwise mutual information PMI(d_{A},d_{B}), which is defined as:

$$PMI ( {d}_{A} , {d}_{B} ) = ln \frac{p ( {d}_{A} , {d}_{B} )}{p ( {d}_{A} ) \cdot p ( {d}_{B} )} , \qquad ( 1 )$$

where p(d_{A}, d_{B}), p(d_{A}) and p(d_{B}) are empirical estimates of the probabilities of co-occurrence of domain name queries d_{A} and d_{B} and their individual occurrence, respectively. These probabilities may be calculated from the data described in FIGS. 5 to 7 using a form of maximum likelihood estimation given by equations (2)-(4):

$$\begin{matrix}p ( {d}_{A} , {d}_{B} ) = \frac{c ( {d}_{A} , {d}_{B} )}{N} & ( 2 ) \\ p ( {d}_{A} ) = \frac{c ( {d}_{A} )}{N} , & ( 3 ) \\ p ( {d}_{B} ) = \frac{c ( {d}_{B} )}{N} , & ( 4 )\end{matrix}$$

where c(d_{A}, d_{B}) is the number of client sessions in which domain name queries d_{A} and d_{B} co-occur, c(d_{A}) and c(d_{B}) are the numbers of client sessions in which each domain name queries d_{A} and d_{B} occurs, respectively, and N is the total number of client sessions.

Pointwise mutual information may be interpreted to measure the degree to which the empirically estimated co-occurrence probability p(d_{A}, d_{B}) of two queries d_{A} and d_{B} differs from a hypothetical probability p*(d_{A}, d_{B})=p(d_{A})p(d_{B}) of their co-occurrence computed under the assumption that they are probabilistically independent. In particular, if the two queries always co-occur in the data, then p(d_{A}, d_{B})=p*(d_{A}, d_{B}) and PMI(d_{A}, d_{B})=0. An order-invariant version of this estimate makes no note of which query arrives first, taking into account only the event of their co-occurrence. An order-specific version of this method considers different orders of co-occurrence to be distinct and thus, estimates two different association scores for each ordering of a pair of queries, i.e., a PMI(d_{A}, d_{B}) and a PMI(d_{B}, d_{A}).

A potential shortcoming of pointwise mutual information PMI may be illustrated using a concrete example, which is presented for exemplification and not to limit the embodiments. The numbers (scores) provided for this example are real numbers calculated for real web sites, based on an actual implementation of this exemplary embodiment. Table 1 shows in its first two columns 10 domain names with the highest (order-invariant) pointwise mutual information score when d_{A} is travelocity.com, a domain that provides online travel services.

It can be seen from Table 1 that some of the top-scoring domains have no apparent topical relatedness to travelocity.com. In particular, the domain kcfx.com contains information related to a radio music station. Examination of the data, provided for example from a DNS server as DNS data, shows that queries for kcfx.com occur in only two client sessions associated with the same IP address, both time co-occurring with queries for travelocity.com. In this case c(d_{A})=3192, c(d_{B})=c(d_{A}, d_{B})=2. Thus, the pointwise mutual information score is no different for a domain name dc for which c(d_{C})=c(d_{A}, d_{C})=2·10³, as can be seen from the following equation:

$$\begin{matrix}PMI ( {d}_{A} , {d}_{B} ) = ln \frac{c ( {d}_{A} , {d}_{B} ) / N}{c ( {d}_{A} ) / N \cdot c ( {d}_{B} ) / N} \\ = ln \frac{c ( {d}_{A} , {d}_{B} ) \cdot {10}^{3} / N}{c ( {d}_{A} ) / N \cdot c ( {d}_{B} ) \cdot {10}^{3} / N} \\ = PMI ( {d}_{A} , {d}_{C} ) .\end{matrix} \qquad ( 6 )$$

Therefore, the pointwise mutual information appears to suffer from artifacts of over-estimated association for infrequently observed events.

This defect is remedied in an exemplary embodiment that uses a novel modification of the pointwise mutual information, the probability-weighted pointwise mutual information (PWPMI). The probability-weighted pointwise mutual information may be obtained by multiplying the pointwise mutual information by p(d_{A}, d_{B}), as shown below:

$$PWPMI ( {d}_{A} , {d}_{B} ) = p ( {d}_{A} , {d}_{B} ) \cdot ln \frac{p ( {d}_{A} , {d}_{B} )}{p ( {d}_{A} ) \cdot p ( {d}_{B} )} . \qquad ( 7 )$$

One skilled in the art will appreciate that other probabilistic association estimates, such as the likelihood ratio and information gain, computed based on the counts domain names and domain name pairs, can be used in place of PWPMI.

According to this exemplary embodiment, by multiplying the pointwise mutual information (PMI) by p(d_{A}, d_{B}), as shown in equation (7), the estimated strengths of association are leveraged out with a factor that favors frequently requested domains, thus removing the statistical “noise” introduced by rare events. This is illustrated in the last two columns of Table 1, where all of the domains are related to travel and most are operated by well-known service providers. Thus, the PWPMI score may be a good candidate for a relatedness score.

TABLE 1

| PMI(d_{A}, d_{B}) | | PWPMI(d_{A}, d_{B}) | |
|---|---|---|---|
| Score | d_{B} | Score | d_{B} |
| 5.3360 | discounthawaiicarrental.com | 0.0023 | expedia.com |
| 5.3360 | kcfx.com | 0.0020 | cheaptickets.com |
| 5.3360 | lansingcenter.com | 0.0017 | orbitz.com |
| 5.3360 | nationalcoalition.org | 0.0015 | priceline.com |
| 5.3360 | poipubeach.com | 0.0014 | hotels.com |
| 5.3360 | stmartin-hotel.com | 0.0013 | lmdeals.com |
| 5.3360 | suncoastblues.org | 0.0012 | wctravel.com |
| 5.3360 | travelcity.com | 0.0012 | hotwire.com |
| 5.3360 | travelocity.co.in | 0.0011 | expediaguides.com |
| 5.3360 | tropicanalv.com | 0.0011 | igougo.com |

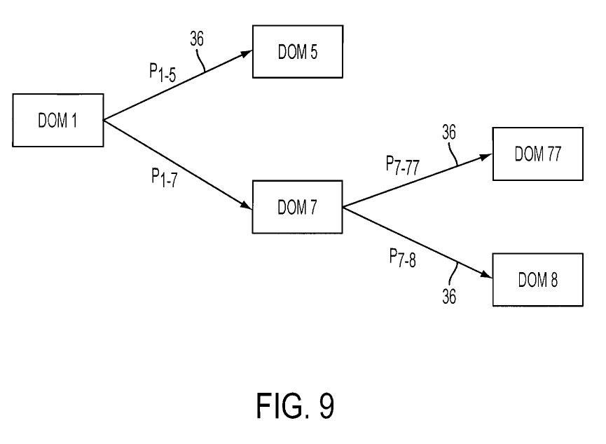

By calculating the novel “PWPMI” probability for each pair of domains requested by the clients of a certain ISP, a path tree for each domain name may be constructed, as shown in FIG. 9. Each domain name DOMi (di) is connected to one or more other domain names via a corresponding direct path 36. Each path indicates possible sequences of domain names that are requested by a client. Each path may be associated with a probability (computed, for example, by dividing each relatedness score by the sum of scores associated with all connections between di and other domains) for traveling, for example, from domain DOM7 to DOM8. This probability p7-8, may be calculated by using the probability PMI, the more complex and accurate probability PWPMI, or other probabilities or combinations of probabilities. These calculated scores indicate, for example, for a generic user visiting domain DOM7, the most likely next domain to be visited based on the collective wisdom, i.e., the experience of the previous users. For example, if DOM8 is more likely to be related in terms of relatedness to DOM7 than DOM77, the estimated p₇₋₈ is likely to be higher than the estimated p₇₋₇₇. This is true because most users tend to exhibit similar behavior patterns.

These scores are calculated for pairs of domain names based on data captured and/or stored in the DNS. As discussed above, the DNS (described in patent application Ser. No. 11/550,975, entitled “Methods and Systems for node ranking based on DNS session data,” by A. Sullivan, assigned to Paxfire, the entire content of which is incorporated herein by reference) is a distributed Internet service typically used to associate domain names with corresponding Internet Protocol (IP) addresses. The DNS may serves as the “phone book” for the Internet by translating human-readable computer hostnames, e.g. www.paxfire.com, into IP addresses, e.g. 207.57.198.126. In response to a request to a DNS server, which is, e.g., sent by a DNS client as a result of a user clicking on a link in a browser, the DNS resolves a hostname to an IP address, which the client then uses to send an HTTP request to the domain that stores the requested page.

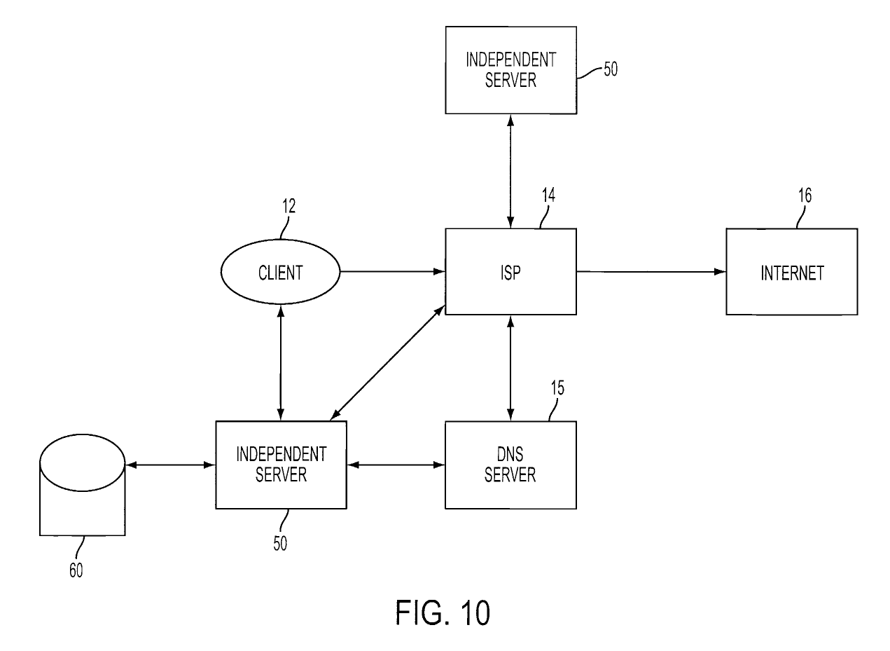

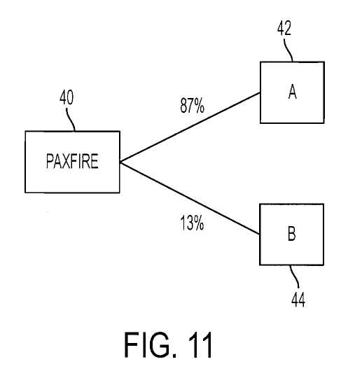

According to an exemplary embodiment, a method for calculating a probabilistic association score measuring a relatedness of pairs of domain names requested by clients may be implemented at the ISP 14 provider or at another location outside the ISP, for example, an independent server 50 connected to the ISP 14 as shown in FIG. 10, at the client 12, and/or at the DNS server 15. More specifically, with regard to FIG. 11, assume that the client is visiting the domain named “Paxfire.com,” which provides specialized solutions for media interfaces. If the user intends to compare the products offered by Paxfire with similar products offered by the competition but the user does not know who the competition of Paxfire is, according to an exemplary embodiment the user may perform a domain name search (based on the above described method) instead of a keyword search to find out those domain names that are related to Paxfire.

If the user enters the name Paxfire.com in the search engine shown in FIG. 2, the search engine will communicate with an application located, for example, on the independent server 50 to search a database 60, which stores the relatedness score for the domain servers. The search on the database 60 identifies the domain names most related to Paxfire.com, which happens to be A.com and B.com in this particular example. For this example, it is assumed that Paxfire provides media solutions to the A provider and the degree of association of Paxfire and A.com is 87% while the degree of association of Paxfire.com and B.com (a domain name belonging to a company that produces hardware for set top boxes) is only 13%. Thus, the probabilistic association method is able to identify that A.com is more related to Paxfire.com than any other domain name and also to identify other related domains, i.e., site B.

In response to the query of the user, the independent server 50, based on the already calculated PWPMI of Paxfire and other domain names, provides the user with A and B's domain names (or other information pointing the user toward A and B's domains, e.g., a complete URL or link to a URL associated with A and B's domains) instead of any other domains, based on the high correlation between Paxfire and A and B.

In addition or alternatively, the independent server 50 may provide the user with ads related to the A and/or B domains, i.e., ads associated with the most related domains to Paxfire. It is noted that the independent server 50 may inform the A or B companies about the appropriate ad to be provided to the user and the companies then provide the ad to the user. Thus, most of the users that visit Paxfire.com are automatically provided with information and/or the web site of A and/or B when searching by domain name.

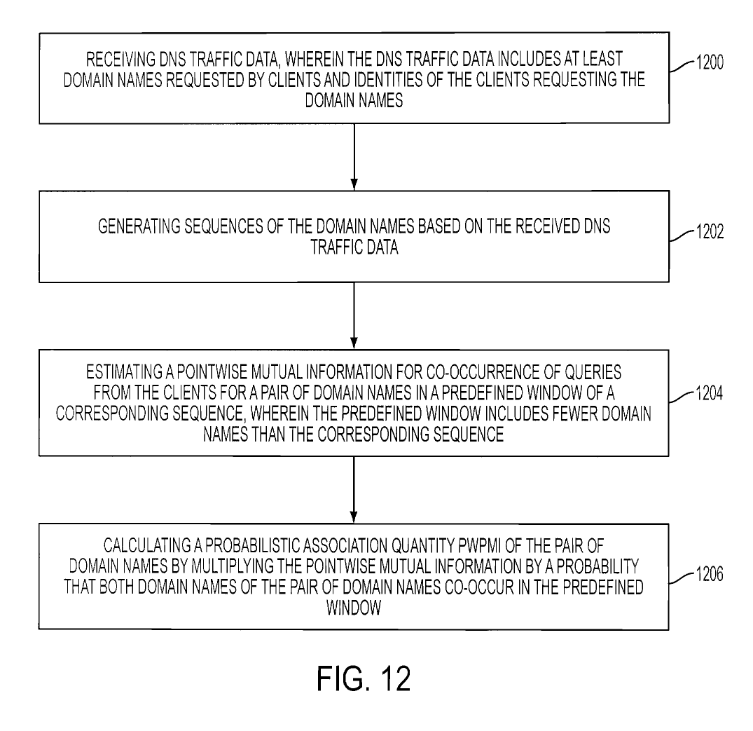

According to an exemplary embodiment, there is a method for calculating a probabilistic association score which measures the relatedness of pairs of domain names requested by clients, as shown in FIG. 12. Domain information is accessible via an Internet service provider, and the clients are connected to the Internet service provider. According to the method, there is a step 1200 of receiving DNS traffic data, wherein the DNS traffic data includes at least domain names requested by clients and identities of the clients requesting the domain names, a step 1202 of generating sequences of the domain names based on the received DNS traffic data, a step 1204 of estimating a pointwise mutual information for co-occurrence of queries from the clients for a pair of domain names in a predefined window of a corresponding sequence, where the predefined window includes fewer domain names than the corresponding sequence, and a step 1206 of calculating a probabilistic association quantity PWPMI of the pair of domain names by multiplying the pointwise mutual information by a probability that both domain names of the pair of domain names co-occur in the predefined window.

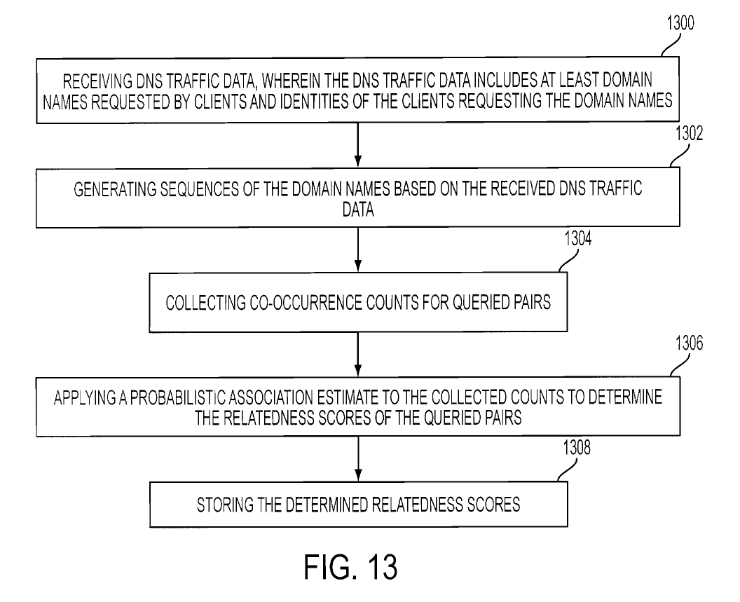

According to another exemplary embodiment, there is a method for calculating a relatedness score, which is indicative of relatedness of pairs of domain names requested by clients. The steps of this method are illustrated in FIG. 13. The method includes a step 1300 of receiving DNS traffic data, wherein the DNS traffic data includes at least domain names requested by clients and identities of the clients requesting the domain names, a step 1302 of generating sequences of the domain names based on the received DNS traffic data, a step 1304 of collecting co-occurrence counts for queried pairs, a step 1306 of applying a probabilistic association estimate to the collected counts to determine the relatedness scores of the queried pairs, and a step 1308 of storing the determined relatedness scores.

According to an exemplary embodiment, the relatedness of a pair of domain names may be determined by combining scores determined with the probabilistic method with scores determined with other methods, for example, the distribution similarity method described in Subotin. The weights of such scores may be determined such that the final results fit the real relatedness of the considered domain names.

In order to evaluate the accuracy of the described exemplary embodiments for indentifying topically related domains, a freely downloadable Internet directory (DMOZ), manually created through voluntary efforts of the public, is used to compare categorizations which are calculated based on the exemplary embodiments. The DMOZ directory assigns websites and web pages into one or more categories organized into a topical hierarchy. At the time of filing this patent application, the hierarchy included 17 categories of depth 1 (such as “Business” and “Health”) and 508 categories of depth 2 (such as “Business/Telecommunications” and “Health/Child Health”).

The procedure for using the DMOZ directory to assess the accuracy of the calculated topical relatedness according to the above exemplary embodiments is as follows. For each domain name in a subset of popular sites (called “reference domain name” herein), a list of 10 other domain names was generated with the highest estimated topical relatedness to that domain name, according to a particular model (called “associated domain names” herein). If both the reference domain name and its associated domain name are assigned to at least one DMOZ category of a particular depth, it is considered that the domain name pair has a known classification at that depth. Otherwise, it is considered that the domain name pair does not have a known DMOZ classification. For a domain name pair with a known classification, it is considered that the model classified the associated domain name correctly if DMOZ assignments of the reference and associated domain names share at least one common category at that depth. If DMOZ assignments of the reference and associated domain names in a domain name pair with a known DMOZ classification at a particular depth have no categories in common, then it is considered that the model classified the associated domain name incorrectly.

It is noted that this accuracy score provides a conservative assessment of a model's performance. For example, the following 3 domains containing content related to medicine have no depth 1 and thus, no depth 2 DMOZ category assignments in common: familydoctor.org (Health/Medicine), clinicaltrials.gov (Business/Biotechnology and Pharmaceuticals), medterms.com (Reference/Dictionaries). This accuracy score therefore cannot be used to assess the accuracy of any particular model in absolute terms, since the accuracy of all models will be underestimated by the DMOZ-based score. However, since there is no apparent reason to suppose that the level of this underestimation will be higher for one type of model than for another, the DMOZ-based scores may be used to estimate the relative accuracy of different models and to find optimal settings of their free parameters.

Based on the above noted procedure, an order-invariant pointwise mutual information (PMI), an order-invariant probability-weighted pointwise mutual information (PWPMI) method, and a truncated SVD distributional similarity method were trained starting from an initial set of about 200 million DNS queries submitted from about 400,000 distinct client IP addresses over a period of several days. Quantcast rankings, which are estimated by proprietary methods and made available by Quantcast (Quantcast Corporation, 201 Third St. San Francisco, Calif. 94130), were used for domain name normalization and filtering purposes. Subdomain fields were pruned from left to right until they matched an entry in Quantcast top million sites or until 2 subdomain fields remained, and queries which did not match an entry in Quantcast top million sites were discarded. Queries were further discarded from intermediate sequences if they appeared in the preceding tail of the sequence of length 3, excluding queries already discarded. Intermediate client sequences were split into separate client sessions if the time elapsed between consecutive queries was more than 1 hour, and resulting sequences of over 1000 queries were further split into separate client sessions at intervals of 1000 queries. Client sessions of fewer than 5 queries were discarded.

In computing the PWPMI score, a co-occurrence window of 10 consecutive queries was used in this exemplary embodiment. Domain names appearing only in one client session were discarded in all models. Domain name pairs co-occurring in fewer than 2 client sessions were discarded in both the PWPMI score and in the PMI score. The reference domain name and domain names appearing in a list of domains known to be operated by online advertising agencies were discarded from lists of associated domain names. Examples of the results of the PMI, PWPMI (calculated based on the method illustrated in FIG. 12) and the distribution similarity score are shown in Table 2.

TABLE 2

| | Depth 1 | Depth 2 |
|---|---|---|
| PMI | 45.37 | 30.51 |
| PWPMI | 45.66 | 30.07 |
| Dist. sim. (tSVD, k = 200) | 51.19 | 32.87 |

Based on the above comparisons, it is noted that the PMI model has almost the same DMOZ-based accuracy as the PWPMI model, but much fewer domain names in its output are in DMOZ and their average Quantcast rank is twice the average Quantcast rank of domains in PWPMI lists. In other words, the PWPMI model tends to give highest scores to more popular domains than the PMI model.

According to another exemplary embodiment, the scores of several models may be interpolated into a single score equal to a weighted sum, with the weights tuned to maximize DMOZ-based accuracies.

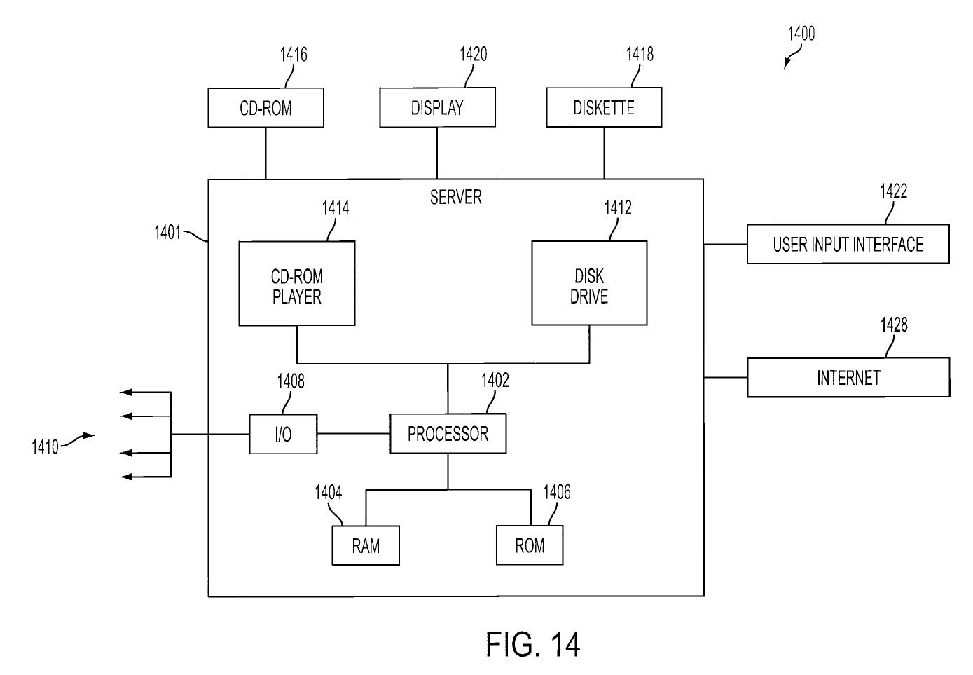

For purposes of illustration and not of limitation, an example of a representative computing system capable of carrying out operations in accordance with the exemplary embodiments is illustrated in FIG. 14. It should be recognized, however, that the principles of the present exemplary embodiments are equally applicable to standard computing systems. Hardware, firmware, software or a combination thereof may be used to perform the various steps and operations described herein.

The exemplary computing arrangement 1400 suitable for performing the activities described in the exemplary embodiments may include a server 1401 with appropriate configuration and access. Such a server 1401 may include a central processor (CPU) 1402 coupled to a random access memory (RAM) 1404 and to a read-only memory (ROM) 1406. The ROM 1406 may also be implemented as other types of storage media to store programs, such as a programmable ROM (PROM), an erasable PROM (EPROM), etc. The processor 1402 may communicate with other internal and external components through input/output (I/O) circuitry 1408 and bussing 1410, to provide control signals and the like. The processor 1402 carries out a variety of functions as is known in the art, as dictated by software and/or firmware instructions.

The server 1401 may also include one or more data storage devices, including hard and floppy disk drives 1412, CD-ROM drives 1414, and other hardware capable of reading and/or storing information such as DVD, etc. In one embodiment, software for carrying out the above discussed steps may be stored and distributed on a CD-ROM 1416, diskette 1418 or other form of media capable of portably storing information. These storage media may be inserted into, and read by, devices such as the CD-ROM drive 1414, the disk drive 1412, etc. The server 1401 may be coupled to a display 1420, which may be any type of known display or presentation screen, such as LCD displays, plasma display, cathode ray tubes (CRT), etc. A user input interface 1422 is provided, including one or more user interface mechanisms such as a mouse, keyboard, microphone, touch pad, touch screen, voice-recognition system, etc.

The server 1401 may be coupled to other computing devices, such as landline and/or wireless terminals and associated watcher applications, via a network. The server may be part of a larger network configuration as in a global area network (GAN) such as the Internet 1428, which allows ultimate connection to the various landline and/or mobile client devices.

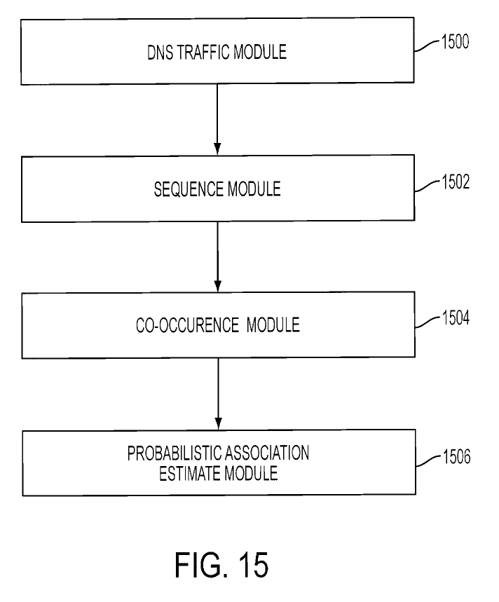

The processor 1402 of the server 1401 may be programmed to generate specific modules for implementing the methods illustrated in FIGS. 12 and/or 13. According to an exemplary embodiment shown in FIG. 15, the modules may include a DNS traffic module 1500 for receiving DNS data, a sequence module 1502 for generating sequences of domain names, a co-occurrence module 1504 for calculating counts of co-occurrence of domain names, and a probabilistic association estimate module 1506 for applying a probabilistic estimate to the calculated counts provided by the co-occurrence module 1504.

The disclosed exemplary embodiments provide a server, a method and a computer program product for identifying domain names that are related to each other. It should be understood that this description is not intended to limit the invention. On the contrary, the exemplary embodiments are intended to cover alternatives, modifications and equivalents, which are included in the spirit and scope of the invention as defined by the appended claims. For example, according to exemplary embodiments, a search engine's graphical user interface can provide options for the user input to be considered as a keyword (i.e., perform a traditional keyword search using the input(s)), a domain name (i.e., perform a domain name relatedness search using the input(s)), or both (i.e., perform both a traditional keyword search using the inputs and a domain name relatedness search using the input(s) and combine or select results from both searches to be displayed to the user). Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

What is claimed is:

1. A method for calculating relatedness scores, which are indicative of relatedness of pairs of domain names requested by clients, the method comprising:
receiving domain name system (DNS) traffic data, wherein the DNS traffic data includes at least domain names requested by clients and identities of the clients requesting the domain names;
generating sequences of the domain names based on the received DNS traffic data;
collecting co-occurrence counts for queried pairs of domain names;
applying a probabilistic association estimate to the collected counts to determine the relatedness scores of the queried pairs of domain names; and
storing the determined relatedness scores.

2. The method of claim 1, wherein the probabilistic association estimate includes at least one of pointwise mutual information (PMI), probability-weighted pointwise mutual information (PWPMI), likelihood ratio or information gain.

3. The method of claim 2, wherein the PWPMI is calculated by
estimating the PMI for co-occurrence of queries of a pair of domain names in a predefined window of a corresponding sequence, wherein the predefined window includes fewer domain names than the corresponding sequence; and
calculating the PWPMI of the pair of domain names by multiplying the PMI by a probability that both domain names of the pair of domain names co-occur in the predefined window.

4. The method of claim 3, wherein the estimating step comprises:
calculating the PWPMI as
$$PWPMI ( {d}_{A} , {d}_{B} ) = p ( {d}_{A} , {d}_{B} ) \cdot ln \frac{p ( {d}_{A} , {d}_{B} )}{p ( {d}_{A} ) \cdot p ( {d}_{B} )} , \qquad$$
where probability p(d_{A}) is a ratio of a number of client sessions in which domain name d_{A} occurs and a total number of client sessions,
p(d_{B}) is a ratio of a number of client sessions in which domain name d_{B} occurs and the total number of client sessions,
p(d_{A}, d_{B}) is a ratio of a number of client sessions in which domain names d_{A} and d_{B} co-occur and the total number of client sessions, and
a client session includes a sequence of domain names requested by a client during a predetermined period of time.

5. The method of claim 3, wherein the predefined window includes between 3 and 10 different domain names.

6. The method of claim 3, wherein the predefined window is time based and includes a predefined amount of time between two queries.

7. The method of claim 1, further comprising:
receiving a time stamp for each domain name requested by the clients; and
calculating the relatedness score by taking into account an order in time of the requested domain names.

8. The method of claim 1, further comprising:
calculating the relatedness score for all pairs of available domain names in the Internet service provider; and
generating a database that stores the calculated relatedness scores for the available domain names.

9. A server for calculating relatedness scores, which are indicative of a relatedness of pairs of domain names requested by clients, the server comprising:
an input/output interface configured to receive domain name system (DNS) traffic data, wherein the DNS traffic data includes at least domain names requested by clients and identities of the clients requesting the domain names;
a processor connected to the input/output interface and configured to,
generate sequences of the domain names based on the received DNS traffic data,
collect co-occurrence counts for queried pairs of domain names, and
apply a probabilistic association estimate to the collected counts to determine the relatedness scores of the queried pairs of domain names; and
a memory connected to the processor and configured to store the determined relatedness scores.

10. The server of claim 9, wherein the probabilistic association estimate includes at least one of pointwise mutual information (PMI), probability-weighted pointwise mutual information (PWPMI), likelihood ratio or information gain.

11. The server of claim 10, wherein the processor is further configured to calculate the PWPMI as
$$PWPMI ( {d}_{A} , {d}_{B} ) = p ( {d}_{A} , {d}_{B} ) \cdot ln \frac{p ( {d}_{A} , {d}_{B} )}{p ( {d}_{A} ) \cdot p ( {d}_{B} )} ,$$
where probability p(d_{A}) is a ratio of a number of client sessions in which domain name h_{A} occurs and a total number of client sessions,
p(d_{B}) is a ratio of a number of client sessions in which domain name d_{B} occurs and the total number of client sessions,
p(d_{A}, d_{B}) is a ratio of a number of client sessions in which domain names d_{A} and d_{B} co-occur and the total number of client sessions, and
a client session includes a sequence of domain names requested by a client during a predetermined period of time.

12. The server of claim 9, wherein the processor input/output interface is further configured to receive a time stamp for each domain name requested by the clients, and the processor is configured to calculate the relatedness score by taking into account an order in time of the requested domain names.

13. The server of claim 9, wherein the processor is further configured to,
calculate the relatedness score for all pairs of available domain names in the Internet service provider; and
generate a database that stores the calculated probabilistic association scores for the available domain names.

14. A computer readable medium storing computer executable instructions, wherein the instructions, when executed, implement a method for calculating relatedness scores, which are indicative of a relatedness of pairs of domain names requested by clients, the method comprising:
providing a system comprising distinct software modules, wherein the distinct software modules comprise a domain name system (DNS) traffic module, a sequence module, a co-occurrence module, and a probabilistic association estimate module;
receiving at the DNS traffic module DNS traffic data, wherein the DNS traffic data includes at least domain names requested by clients and identities of the clients requesting the domain names;
generating by the sequence module sequences of the domain names based on the received DNS traffic data;
collecting co-occurrence counts for queried pairs of domain names in the co-occurrence module;
applying, in the probabilistic association estimate module, a probabilistic association estimate to the collected counts to determine the relatedness scores of the queried pairs of domain names; and
storing the determined relatedness scores.

15. The medium of claim 14, wherein the probabilistic association estimate includes at least one of pointwise mutual information (PMI), probability-weighted pointwise mutual information (PWPMI), a likelihood ratio or information gain.

16. The medium of claim 15, wherein PWPMI is calculated by
estimating the PMI for co-occurrence of queries of a pair of domain names in a predefined window of a corresponding sequence, wherein the predefined window includes fewer domain names than the corresponding sequence; and
calculating the PWPMI of the pair of domain names by multiplying the PMI by a probability that both domain names of the pair of domain names co-occur in the predefined window.

17. The medium of claim 16, wherein the estimating step comprises:
calculating the PWPMI as
$$PWPMI ( {d}_{A} , {d}_{B} ) = p ( {d}_{A} , {d}_{B} ) \cdot ln \frac{p ( {d}_{A} , {d}_{B} )}{p ( {d}_{A} ) \cdot p ( {d}_{B} )} ,$$
where probability p(d_{A}) is a ratio of a number of client sessions in which domain name d_{A} occurs and a total number of client sessions,
p(d_{B}) is a ratio of a number of client sessions in which domain name d_{B} occurs and the total number of client sessions,
p(d_{A}, d_{B}) is a ratio of a number of client sessions in which domain names d_{A} and d_{B} co-occur and the total number of client sessions, and
a client session includes a sequence of domain names requested by a client during a predetermined period of time.

18. The medium of claim 14, further comprising:
receiving a time stamp for each domain name requested by the clients; and
calculating the relatedness score by taking into account an order in time of the requested domain names.

19. The medium of claim 14, further comprising:
calculating the relatedness score for all pairs of available domain names in the Internet service provider; and
generating a database that stores the calculated relatedness scores for the available domain names.
